(19) United States
(12) Patent Application Publication
(10) Pub. No.: US 2014/0217802 A1
(43) Pub. Date: Aug. 7, 2014

(54) Prostate automobile and truck seat

(71) Applicant: Eugene Daniel Lucas, Dunmore, PA (US)

(72) Inventor: Eugene Daniel Lucas, Dunmore, PA (US)

(21) Appl. No.: 13/815,183

(22) Filed: Feb. 7, 2013

(51) Int. Cl. B60N 2/44

(52) U.S. Cl. CPC B60N 2/44
USPC 297/452.41

(57) ABSTRACT

There is provided an adjustable air chamber which is located beneath the prostate area that is housed within the cushion of the seat contour which may be vertically deflated and reinflated 1½ inches by utilizing an electronic two-position switch located alongside the automobile and truck seat.

The rider may select the desired position to allow for maximum rider comfort. The electronic pump would be actuated by a motor controlled by the electronic two-position switch and force air into the air chamber. A pressure valve between the pump and air chamber would be used to bleed off excessive air to prevent over inflation. Accordingly, the prostate automobile and truck seat would eliminate contact on the prostate thereby reducing the risk of deleterious effects on the rider's prostate.

### RELATED APPLICATIONS

This application claims priority to the patent of Lucas (U.S. Pat. No. 8,113,583 B2) filed Apr. 9, 2009 the benefit of which it is hereby claimed under 35 U.S.C. 119 (e).

### FIELD OF INVENTION

The prostate automobile and truck seat allows a rider to utilize an electronic two-position switch alongside the seat which causes a pump to deflate or reinflate an air chamber beneath the prostate thereby creating a gap of up to 1½ inches between the prostate and the seat. The prostate automobile and truck seat would permit an individual to pump air out or in an air chamber to adjust the air space between the seat and the prostate to allow for increased rider comfort.

Prior patents have dealt with adjustments of the seat length, seat width, arm dividers, seat back adjustments and the entire seat tilt adjustments. The prostate automobile and truck seat has a power control to allow a portion of the seat to decrease or increase vertically 1½ inches thereby allowing for individual rider comfort. As men age their prostate begins to enlarge. The larger the prostate the more impact it will have with the seat.

The present invention of providing an air space between the prostate and the seat is designed to eliminate the impact of the prostate on the automobile and truck seat.

### BACKGROUND OF THE INVENTION

Automobile and truck seats without prostate protection are commonly used throughout the world. Continuous bumping and jarring of the prostate area during the ride over time may cause the prostate to become inflamed, precipitating or worsening a variety of chronic and acute prostate conditions.

### SUMMARY OF THE INVENTION

The present invention eliminates the impact on the prostate by providing up to 1½ inches of air space between the seat and the prostate. This is achieved by the use of a pump powered by a motor and controlled with a two-position switch that deflate or reinflate an air chamber beneath the prostate. The air chamber which is housed in the seat contour would deflate vertically 1½ inches to allow for greater rider comfort and minimize the impact on the prostate.

### BRIEF DESCRIPTION OF DRAWINGS

FIG. 1 represents the three-dimensional view of the prostate automobile and truck seat;

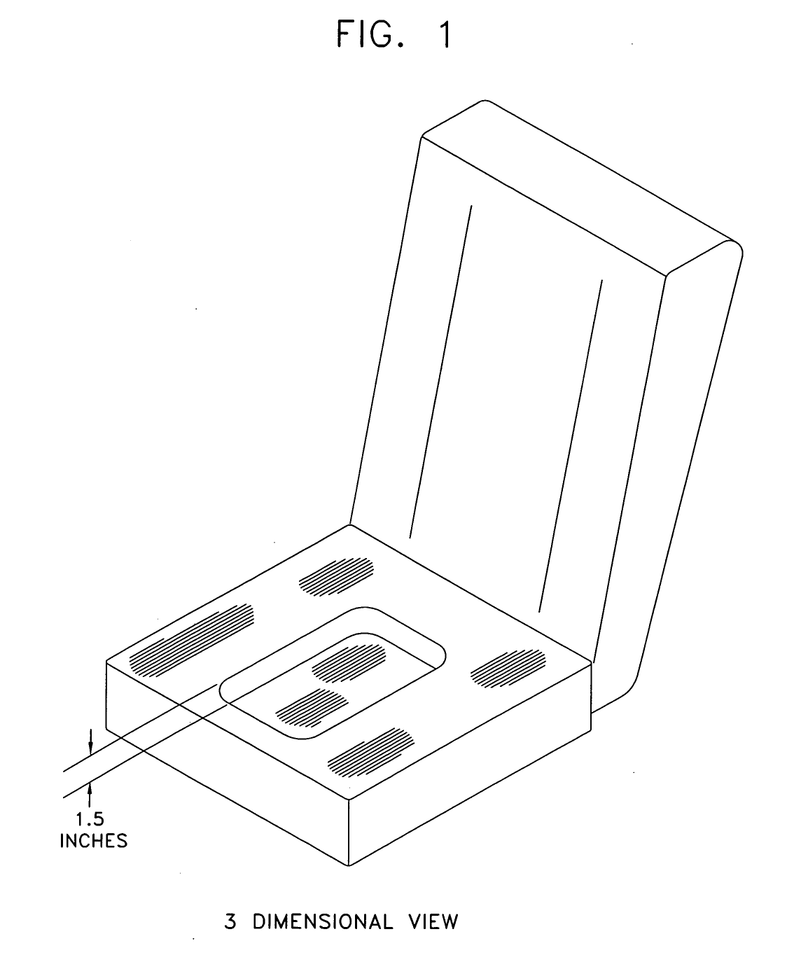

FIG. 2 is a perspective view showing the composition of the essential parts of the present invention consisting of a system in the embodiment of the seat structure whereby an air chamber 1 housed within the seat contour and actuated by a two-position switch 2 which is connected to a motor 9 that controls the pump 10 that rests below the prostate area on the prostate automobile and truck seat; whereby the contacts 3 and 4 are used for inflating and deflating the air chamber 1 by utilization of the two-position switch 2. The reversible pump 10 pushes the air through the release valve 6 and into the air chamber 1. The lead wire 8 comes directly from the two-position switch and continues into the motor 9 which forces air by means of a reversible pump 10 through an air line 11 into the air chamber 1. The pressure valve rests between the air chamber 1 and the pump to allow excess air to be bled off through the use of a release valve 6. The reverse airline 13 also empties into the release valve 6 and any excess air from the pressure valve 12 will also exhaust through the release valve;

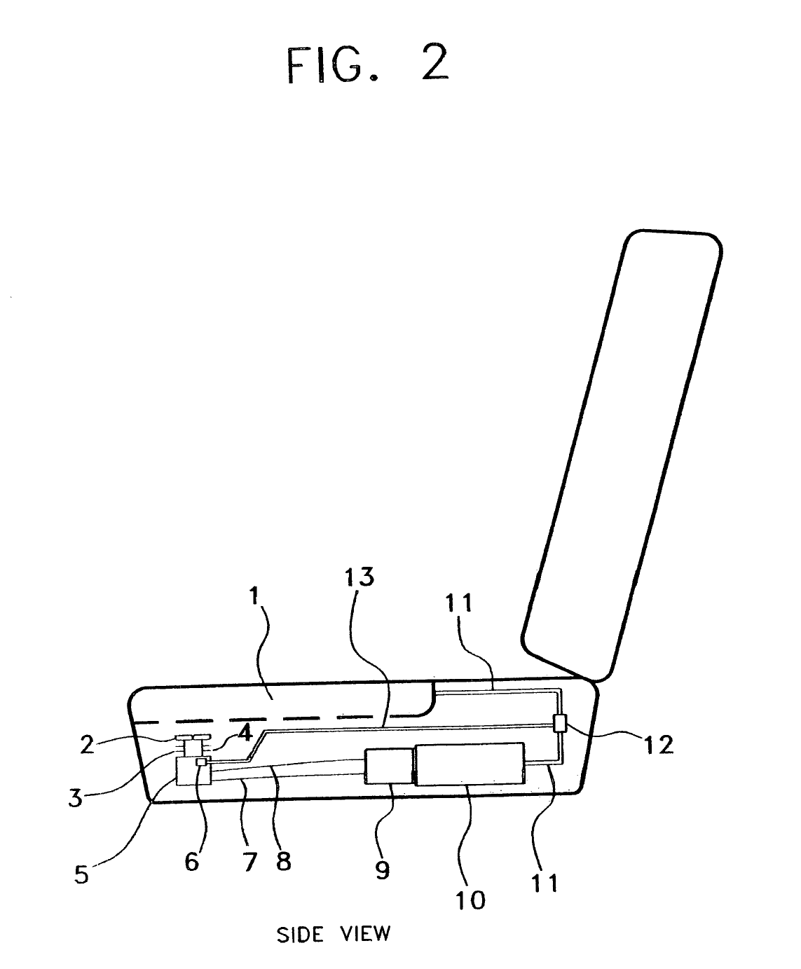

FIG. 3 represents the front of the prostate automobile and truck seat; and

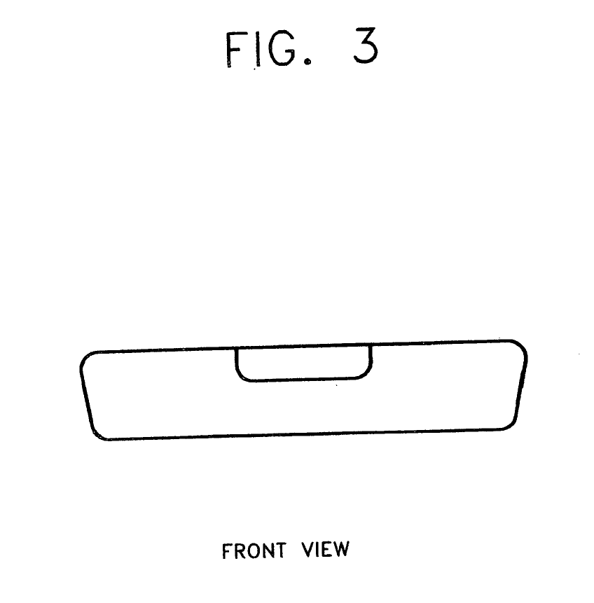

FIG. 4 represents the top view of the prostate automobile and truck seat;

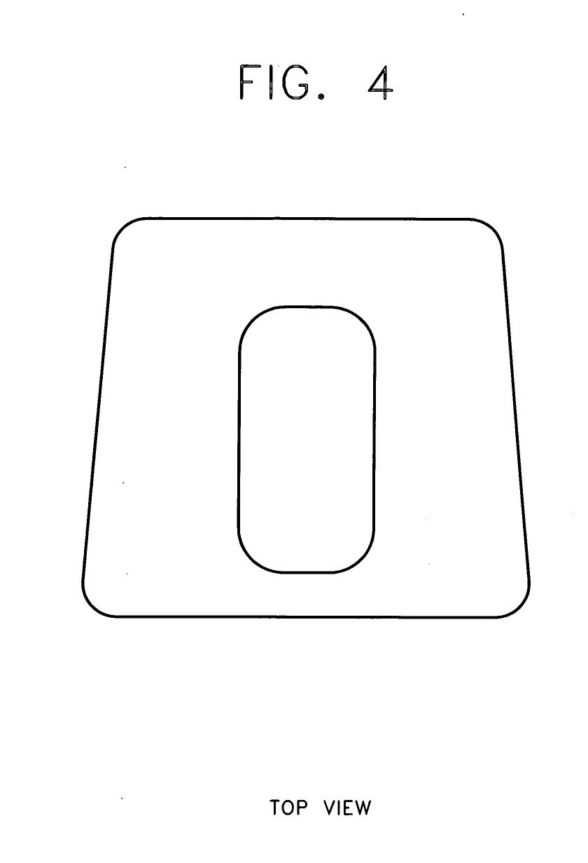

### DETAILED DESCRIPTION OF THE PROSTATE AUTOMOBILE AND TRUCK SEAT

The present invention is a continuation of the patent of Lucas U.S. Pat. No. 8,113,583B2. The Examiner is Erika Garret. The Art Unit is 3636.

The prostate golf cart seat, prostate air seat and prostate automobile and truck seat all provide protection to the prostate area by providing a 1½ inches of air space between the seat and the prostate. Accordingly, the impact on the prostate is eliminated. The prostate automobile and truck seat consists of an air chamber which is housed within the seat contour and is actuated by a two-position switch located alongside the rider's seat which is connected to a motor that controls the pump beneath the prostate which can be deflated to 1½ inches thereby eliminating the impact on the rider's prostate.

During the course of driving, continuous bumping occurs over the prostate area. Conventional automobile and truck seats exert the rider's weight throughout the rider's prostate area. Conventional automobile and truck seats do not protect the prostate during the duration of a ride. The prostate automobile and truck seat is designed to eliminate the impact on a man's prostate.

The prostate automobile and truck seat consists of an air chamber which may be deflated to 1½ inches to eliminate the impact on the prostate. This is achieved by using a two-position switch which activates a pump to deflate or reinflate an air space beneath the prostate area. A pressure control valve is utilized to prevent over inflation.

Other modifications are possible within the scope of the claim illustrated by this invention. In the alternative, the air chamber may utilize cylinders such as a hydraulic cylinder or a motor-drive cylinder which are mechanically driven to deflate and inflate the air chamber.

What is claimed is:

1. A prostate automobile and truck seat comprising:
one two-position switch connected to a deflatable and reinflatable pump;
whereby an air chamber can be deflated and reinflated up to 1½ inches;
whereby the air chamber moves vertically beneath the prostate to 1½ inches;
whereby the rider can make electronic adjustments to achieve maximum rider comfort.
